(19) United States
(12) Patent Application Publication
(10) Pub. No.: US 2003/0236741 A1
(43) Pub. Date: Dec. 25, 2003

(54) Method for calculating loss on business, loss calculating program, and loss calculating device

(76) Inventors: Osamu Kubo, Hitachi (JP); Takeshi Yokota, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/370,631

(22) Filed: Feb. 24, 2003

(30) Foreign Application Priority Data
Jun. 21, 2002 (JP) 2002-181536

(51) Int. Cl. G06F 17/60

(52) U.S. Cl. 705/38

(57) ABSTRACT

A method for calculating a loss in business that can exactly calculate losses, which will occur in the future in business, and their variance in particular is provided. For a plurality of business processes constituting business, an error occurrence rate 0113 in each business process, and probability distribution of losses 0114 produced when an error has occurred in the business processes, are used as inputs. In addition to them, for a transaction handled in the business, a business process transition probability 0112 which denotes a probability that a transaction executed in a preceding business process will be executed in a subsequent business process is used as an input. Losses which will occur in the future in the business are thereby calculated.

### BACKGROUND OF THE INVENTION

The present invention relates to a method for calculating a loss in business constituted of a plurality of business processes, a loss calculating program, and a loss calculating device.

In the conventional method for calculating a loss in business (operational-risk measuring method), the order of execution used when a plurality of business processes constituting the business execute a transaction is not taken into consideration. A loss that will occur in the future is calculated for each of the business processes, and the losses calculated for all business processes are totaled. This totaled loss is treated as a loss which will occur in the future in the business.

Incidentally, it is desirable to calculate a loss in business properly from the viewpoint of an increase in business efficiency of a financial institution, etc. In addition, “the financial inspection manual” of Japan advises as follows: When grasping an operation process risk, it is desirable that the operation process risk should be analyzed from the viewpoint of a potential scale of a loss in business and the possibility that a loss will occur in business. Then, for example, an expected loss or the like is measured, so that risk management is evaluated properly.

However, in the prior art, the order of execution used when a plurality of business processes execute a transaction is not taken into consideration at all. On the other hand, a loss in each of the business processes constituting the business does not occur independently of the other business processes, and a loss in each transaction handled by the business does not occur independently of the other transactions. In other words, a loss occurring in the business is biased according to a business process and a transaction. Therefore, in the prior art, a loss that will occur in the future in business, and particularly variance of losses cannot be exactly calculated.

### SUMMARY OF THE INVENTION

It is therefore a main object of the present invention to provide a method for calculating a loss in business, a loss calculating program, and a loss calculating device, which are capable of properly calculating a loss which will occur in the future in business.

The inventors of the present invention have paid attention to business processes constituting business, and consequently have come to devise the method for calculating a loss, etc. in which a flow of the business processes has been taken into consideration.

According to one aspect of the present invention, in order to solve the problems, for a plurality of business processes constituting business, an error occurrence rate in each business process, and probability distribution of losses produced when an error has occurred in the business processes, are used as inputs. In addition to them, for a transaction handled in the business, a business process transition probability which denotes a probability that a transaction executed in a preceding business process will be executed in a subsequent business process is used as an input. Losses which will occur in the future in the business are thereby calculated. It is to be noted that examples of the losses in business include operational risks such as an operation process risk, a system risk, and a legal risk.

### BRIEF DESCRIPTION OF THE DRAWINGS

Other objects and advantages of the invention will become apparent from the following description of embodiments with reference to the accompanying drawings in which:

FIG. 1 is a flowchart illustrating a method for calculating a loss in business according to one embodiment of the present invention;

FIG. 2 is a diagram illustrating a general configuration of business supported by the method for calculating a loss in business shown in FIG. 1;

FIG. 3 is a diagram illustrating a configuration of loan business in a bank, which is described as an example of the business supported by the method for calculating a loss in business in FIG. 1;

FIG. 4 is a diagram illustrating a configuration of transfer business in a bank, which is described as an example of the business supported by the method for calculating a loss in business in FIG. 1;

FIG. 5 is a diagram illustrating business information used for the method for calculating a loss in business in FIG. 1;

FIG. 6 is a diagram detailing the business-specific loss calculating step in FIG. 1;

FIG. 7 is a diagram illustrating business-specific process transition probability targeted for loan business, which is used for the method for calculating a loss in business in FIG. 1;

FIG. 8 is a diagram illustrating business-specific process transition probability targeted for transfer business, which is used for the method for calculating a loss in business in FIG. 1;

FIG. 9 is a diagram illustrating business-specific error occurrence rate targeted for loan business, which is used for the method for calculating a loss in business in FIG. 1;

FIG. 10 is a diagram illustrating business-specific error occurrence rate targeted for transfer business, which is used for the method for calculating a loss in business in FIG. 1;

FIG. 11 is a diagram illustrating business-specific loss probability distribution targeted for loan business, which is used for the method for calculating a loss in business in FIG. 1;

FIG. 12 is a diagram illustrating business-specific loss probability distribution targeted for transfer business, which is used for the method for calculating a loss in business in FIG. 1;

FIG. 13 is a diagram detailing the transaction-specific loss calculating step in FIG. 6;

FIG. 14 is a flowchart detailing the process-specific loss calculating step in FIG. 13;

FIG. 15 is a diagram detailing the subsequent process judging step in FIG. 13;

FIG. 16 is a flowchart illustrating an example of a case where a subsequent process judging step in FIG. 15 is applied to credit investigation for loaned money in FIG. 3;

FIG. 17 is a diagram illustrating calculated business-specific losses;

FIG. 18 is a flowchart illustrating a risk visualizing method that uses the method for calculating a loss in business in FIG. 1;

FIG. 19 is a diagram illustrating iteration-specific losses;

FIG. 20 is a diagram illustrating statistic of a risk visualized by a risk visualizing process; and

FIG. 21 is a diagram illustrating a configuration of a loss calculating device which executes the method for calculating a loss and a loss calculating program.

### DETAILED DESCRIPTION OF THE PREFERRED EMBODIMENTS

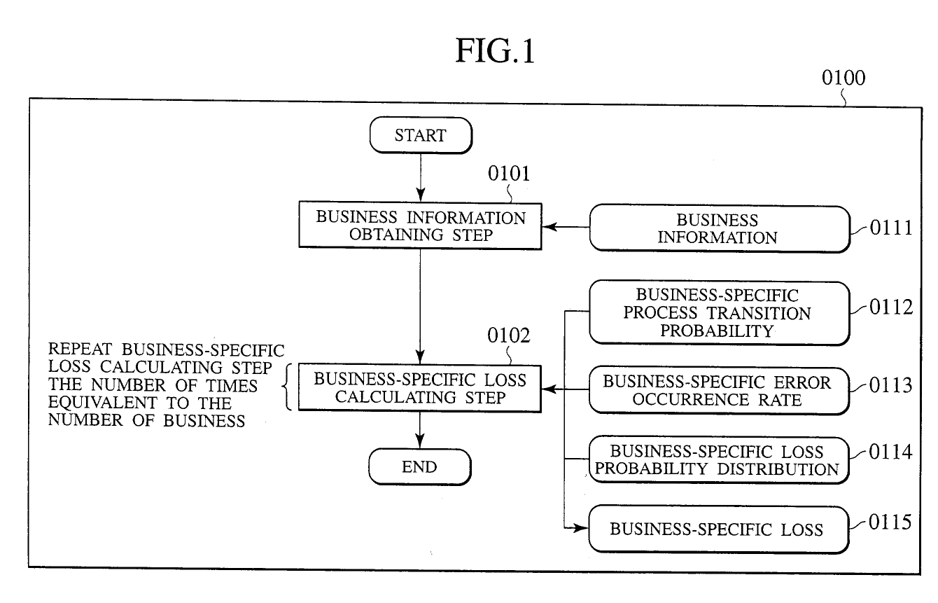

An embodiment of the present invention will be described in detail with reference to drawings below. In this embodiment, a loss occurring, for example, in each business of a bank is converted into numbers, or an operational risk is measured. Additionally, in this embodiment, a loss which will occur in the future in business constituted of a plurality of business processes, in particular, a loss which will occur in the future in bank's business, and variance (distribution) of losses in particular, are exactly calculated. [Method for calculating a loss in business] The method for calculating a loss in business (function of calculating a loss) 0100 in the embodiment shown in FIG. 1 includes a business information obtaining step 0101 and a business-specific loss calculating step 0102. It is to be noted that business information 0111, business-specific process transition probability 0112, and the like, are data.

In the business information obtaining step 0101, the business information 0111 is obtained. The business-specific loss calculating step 0102 as a subsequent stage is repeated the number of business that is included in the business information 0111 obtained in the business information obtaining step 0101. An example of the business information 0111 will be described later with reference to FIG. 5. For example, the business information 0111 relates to loan business, exchange business, etc.

In the business-specific loss calculating step 0102, three kinds of information, i.e., the business-specific process transition probability 0112, business-specific error occurrence rate 0113, and business-specific loss probability distribution 0114 are inputted to calculate a loss which will occur in the future in business, and then the calculated loss is output as business-specific loss 0115. In this connection, this step 0102 is repeatedly executed the number of business (loan business, exchange business, etc.) described in the business information 0111 to calculate the business-specific loss 0115 on a business basis before outputting the business-specific loss 0115.

It is to be noted that the business-specific error occurrence rate 0113 corresponds to “error occurrence rate in business” in claims, and that the business-specific loss probability distribution 0114 corresponds to “probability distribution of losses” in the claims. In addition, the business-specific process transition probability 0112 corresponds to “business process transition probability” in the claims.

[Business Structure Supported by the Method for Calculating a Loss in Business]

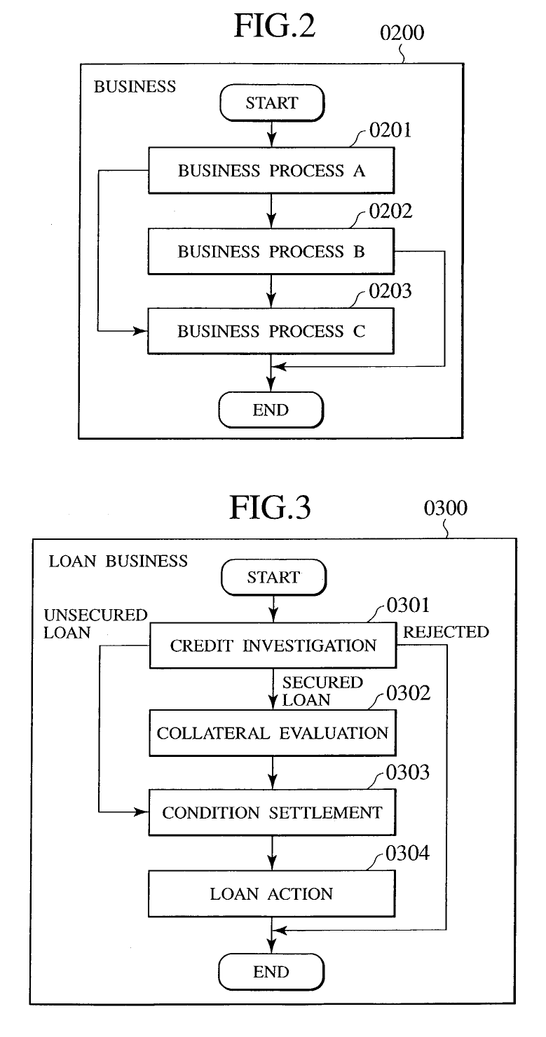

The business structure supported by the method for calculating a loss in business (measurement of a risk) according to the present invention will be described with reference to FIG. 2.

As exemplified in FIG. 2, “business 0200 supported by the method for calculating a loss in business 0100” in this embodiment includes a plurality of business processes. Moreover, the business processes executes a transaction (individual case) handled by business in order. The business 0200 in FIG. 2 includes three business processes, i.e., a business process A 0201, a business process B 0202, and a business process C 0203. Further, in FIG. 2, a process subsequent to the business process A 0201 is the business process B 0202 or the business process C 0203; a process subsequent to the business process B 0202 is the business process C 0203 or no process (END); and a process subsequent to the business process C 0203 is no process (END). It is to be noted that the business 0200 supported by this method for calculating a loss in business 0100 corresponds to “business including a series of processes from a starting process to an ending process” in the claims.

[Example of Business Supported by the Method for Calculating a Loss: Loan Business]

Loan business of a bank as an example of “the business 0200 supported by the method for calculating a loss in business 0100” in the embodiment shown in FIG. 2, will be described with reference to FIG. 3. Loan business 0300 illustrated in FIG. 3 has four business processes: credit investigation 0301, collateral evaluation 0302, condition settlement 0303, and loan action 0304.

For transaction handled by business (for example, a case of a customer A), creditability of a borrower (A) is investigated in the credit investigation 0301. If the customer A passes the investigation in the customer investigation 0301, a subsequent process is the collateral evaluation 0302 in the case of secured loan; or the subsequent process is the condition settlement 0303 in the case of unsecured loan. On the other hand, if the customer A fails in the investigation in the credit investigation 0301, there is no subsequent process (END). In the collateral evaluation 0302, collateral of the secured loan is evaluated. In the condition settlement 0303, conditions of the loan including the term of repayment, an interest rate, and a repayment method, for example, are settled. It is to be noted that in this example, there are two flows of processes to the condition settlement 0303. One is a flow coming to the condition settlement 0303 by way of the collateral evaluation 0302, and the other is a flow coming directly to the condition settlement 0303. In the loan action 0304, which is the last process, loaned money is transferred to an account of the customer A.

In each process of such loan business, a loss occurs due to various kinds of causes for each transaction (the case of the customer A, a case of a customer B, etc.), or a loss does not occur. In this embodiment, the loss that has occurred loss is converted into numbers.

[Example of Business Supported by the Method for Calculating a Loss: Transfer Business]

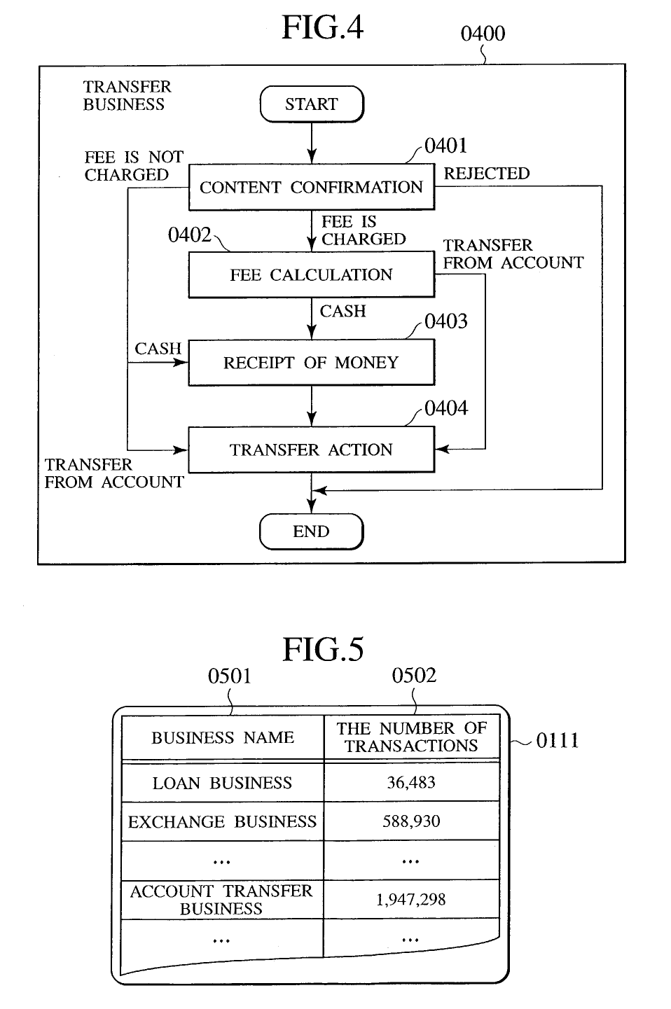

Transfer business of a bank as an example of “the business 0200 supported by the method for calculating a loss in business 0100” in the embodiment shown in FIG. 2 will be described with reference to FIG. 4. The transfer business 0400 illustrated in FIG. 4 has four business processes: content confirmation 0401, fee calculation 0402, receipt of money 0403, and transfer action 0404.

For transaction handled by business (for example, a case of a customer A), contents of transfer of the customer A are confirmed in the content confirmation 0401. If no defect of contents is found in the content confirmation 0401, and in the case of transfer that charges a fee, a subsequent process is the fee calculation 0402. On the other hand, if no defect of contents is found in the contents confirmation 0401 and transfer that does not charge a fee, subsequent processes are the following: for example, if it is transfer from cash, the subsequent process is the receipt of money 0403; and for example, if it is transfer from account, the subsequent process is the transfer action 0404. In addition, if a defect of the contents is found in the contents confirmation 0401, there is no subsequent process (END).

In the fee calculation 0402, a fee is calculated according to the contents of transfer such as the amount of transfer. In the fee calculation 0402, in the case of transfer from cash, a subsequent process is the receipt of money 0403; and in the case of transfer from account, the subsequent process is the transfer action 0404. In the receipt of money 0403, the amount of transfer and a fee are accepted from the customer. In the transfer action 0404, the amount of transfer is transferred to a transferred account.

In each process of such transfer business, a loss occurs due to various kinds of causes for each transaction (the case of the customer A, a case of the customer B, etc.), or a loss does not occur. In this embodiment, the loss that has occurred loss is converted into numbers.

[Business Information]

An example of the business information 0111 in FIG. 1 will be described with reference to FIG. 5. The business information 0111 in FIG. 5 includes a business name 0501 and the number of transactions 0502. FIG. 5 shows that the number of transactions (the number of handling) corresponding to loan business, exchange business, account transfer business, etc. is 36,483, 588,930, 1,947,298, etc. respectively. In this connection, the business name “loan business” in FIG. 5 corresponds to the loan business 0300 illustrated in the flowchart in FIG. 3; and the business name “transfer business” corresponds to the transfer business 0400 illustrated in the flowchart in FIG. 4.

[Business-Specific Loss Calculating Step]

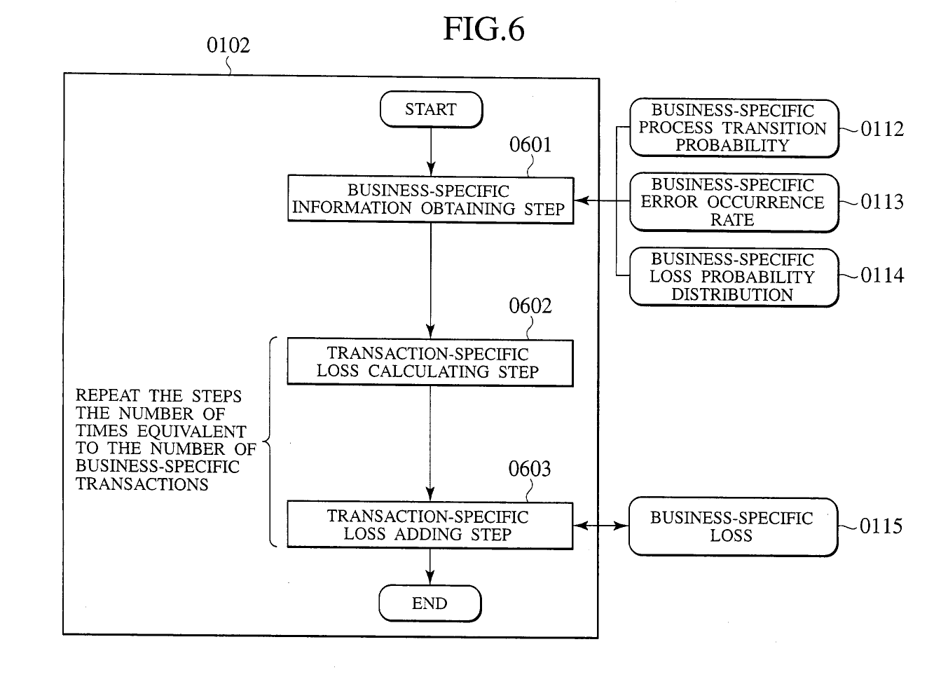

The business-specific loss calculating step 0102 in FIG. 1 will be described with reference to FIG. 6. FIG. 6 is a flowchart detailing the business-specific loss calculating step in FIG. 1.

As will be understood from FIG. 6, the business-specific loss calculating step 0102 in FIG. 1 includes a business-specific information obtaining step 0601, a transaction-specific loss calculating step 0602, and a transaction-specific loss outputting step 0603. It is to be noted that the business-specific process transition probability 0112, the business-specific error occurrence rate 0113 and the like, are data.

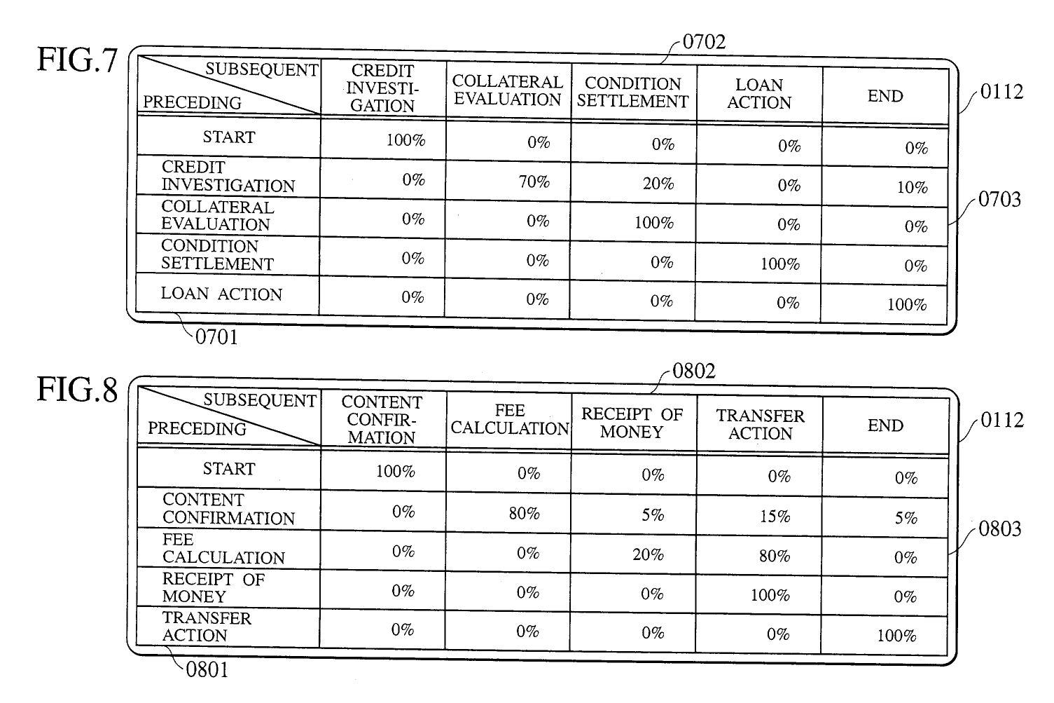

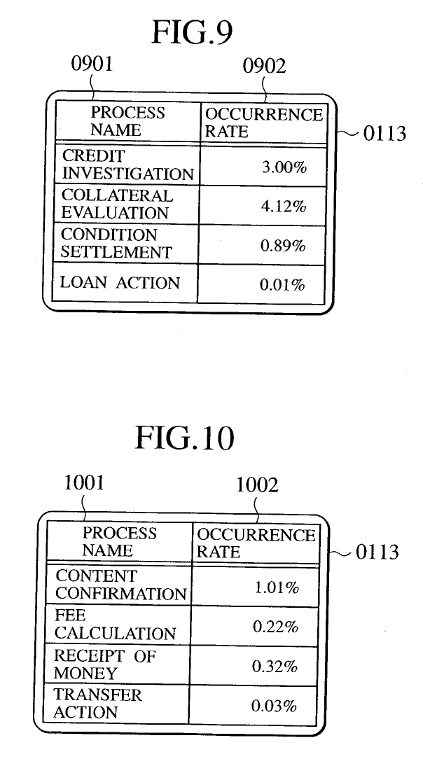

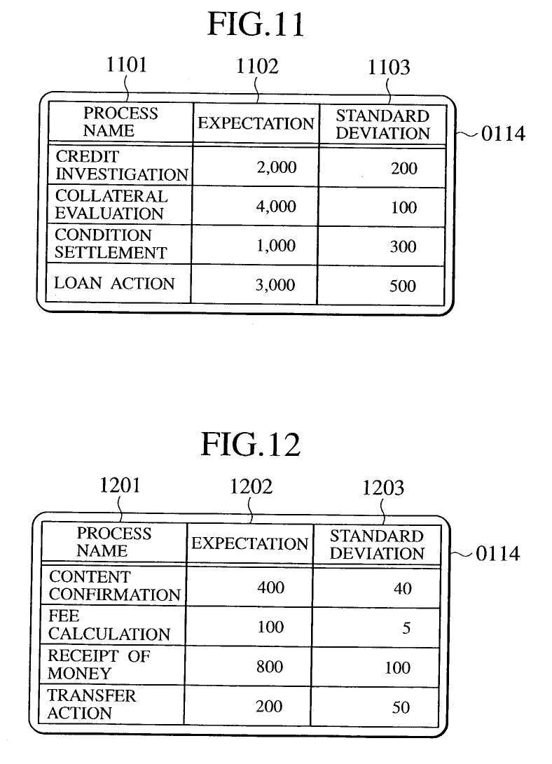

To begin with, in the business-specific information obtaining step 0601, the business-specific process transition probability 0112, the business-specific error occurrence rate 0113, and the business-specific loss probability distribution 0114 are obtained. Here, the business-specific process transition probability 0112, the business-specific error occurrence rate 0113, and the business-specific loss probability distribution 0114 differ according to business. Accordingly, if a loss which will occur in the future in the loan business 0300 illustrated in FIG. 3 is calculated in the business-specific loss calculating step 0102, the business-specific process transition probability 0112, the business-specific error occurrence rate 0113, and the business-specific loss probability distribution 0114, which are used for the loan business 0300, are obtained in the business information obtaining step 0601. Likewise, if a loss which will occur in the future in the transfer business 0400 illustrated in FIG. 4 is calculated in the business-specific loss calculating step 0102, the business-specific process transition probability 0112, the business-specific error occurrence rate 0113, and the business-specific loss probability distribution 0114, which are used for the transfer business 0400, are obtained in the business information obtaining step 0601. Specific examples of the business-specific process transition probability 0112, the business-specific error occurrence rate 0113, and the business-specific loss probability distribution 0114 will be described later with reference to FIGS. 7 and 8 (business-specific process transition probability), FIGS. 9 and 10 (business-specific error occurrence rate), and FIGS. 11 and 12 (business-specific loss probability distribution), respectively.

Next, the transaction-specific loss calculating step 0602 and the transaction-specific loss outputting step 0603 are repeated the number of transactions 0502 that is included in the business information 0111 obtained in the business information obtaining step 0101. More specifically, if the business information 0111 shown in FIG. 5 is obtained, both of the transaction-specific loss calculating step 0602 and the transaction-specific loss outputting step 0603 are repeated as a set 36,483 times for the loan business 0300 (refer to FIG. 3). In other words, in the transaction-specific loss calculating step 0602, the business-specific process transition probability 0112, the business-specific error occurrence rate 0113, and the business-specific loss probability distribution 0114, which have been obtained in the business-specific information obtaining step 0601, are inputted to calculate a loss which will occur in the future for each of 36,483 transactions. In this connection, even if there are 36,483 transactions, the number of times the business-specific process transition probability 0112, the business-specific error occurrence rate 0113, and the business-specific loss probability distribution 0114 are read is only once. That is to say, reading them once in the business-specific information obtaining step 0601 suffices. Incidentally, a loss calculating method in the transaction-specific loss calculating step 0602 will be detailed later.

In the next transaction-specific loss adding step 0603, a loss which will occur in the future in business is calculated by adding a loss which will occur in the future for each transaction calculated in the transaction-specific loss calculating step 0602 to the business-specific loss 0115. If the transaction-specific loss calculating step 0602 calculates a loss 36,483 times, the number of times the loss is added in the transaction-specific loss adding step 0603 is also the same. In other words, if the business information 0111 shown in FIG. 5 is obtained, the business-specific loss 0115 which will occur in the future in the loan business 0300 is the sum of the losses which will occur in 36,483 transactions handled by the loan business 0300.

It is to be noted that the details of the flowchart in FIG. 6 (business-specific loss calculating step 0102) are repeatedly executed the number of business (business name) shown in FIG. 5. To be more specific, the processing is repeated as follows: first, for the loan business, in steps 0602 and 0603, the processing is executed 36,483 times that is the number of transactions; next, for the exchange business, in steps 0602 and 0603, the processing is executed 588,930 times that is the number of transactions; further, for the transfer business, in the steps 0602 and 0603, processing is executed 1,947,298 times that is the number of transactions. In other words, the business-specific loss 0115 is calculated for each of the loan business, the exchange business, the transfer business and the like.

[Business-Specific Process Transition Probability Targeted for Loan Business]

An example of the business-specific process transition probability 0112 in FIGS. 1 and 6, which is targeted for the loan business 0300 shown in FIG. 3, will be described with reference to FIG. 7. FIG. 7 is a diagram illustrating business-specific process transition probability targeted for loan business, which is used for the method for calculating a loss in business in FIG. 1.

As shown in FIG. 7, the business-specific process transition probability 0112 targeted for loan business 0300 consists of a preceding business process 0701, a subsequent business process 0702, and business process transition probability 0703 from the preceding business process 0701 to the subsequent business process 0702.

The first row at the top of FIG. 7 is the caption. The second row of FIG. 7 shows that all business processes for transactions of the loan business 0300 in FIG. 3 begin with the credit investigation 0301 (100 [%]). The third row of FIG. 7 shows that of transactions executed in the credit investigation 0301 in FIG. 3, secured loan which passes investigation (which is judged to have no problem by investigation) is 70 [%], unsecured loan which passes investigation (which is judged to have no problem by investigation) is 20 [%], and loan which does not pass investigation (which is rejected by investigation) is 10 [%]. The fourth row of FIG. 7 shows that all transactions executed in the collateral evaluation 0302 in FIG. 3 proceed to the condition settlement 0303. The fifth row of FIG. 7 shows that all transactions executed in the condition settlement 0303 in FIG. 3 proceed to the loan action 0304. The sixth row of FIG. 7 shows that all of the business processes for the transactions executed in the loan action 0304 in FIG. 3 end there.

It is to be noted that data of the business-specific process transition probability 0112 in FIG. 7 is provided according to the past results, etc.

[Business-Specific Process Transition Probability Targeted for Transfer Business]

An example of the business-specific process transition probability 0112 in FIGS. 1 and 6, which is targeted for the transfer business 0400 shown in FIG. 4, will be described with reference to FIG. 8. FIG. 8 is a diagram illustrating business-specific process transition probability targeted for transfer business, which is used for the method for calculating a loss in business in FIG. 1.

As shown in FIG. 8, as is the case with FIG. 7, the business-specific process transition probability 0112 targeted for the transfer business 0400 consists of a preceding business process 0801, a subsequent business process 0802, and business process transition probability 0803 from the preceding business process 0801 to the subsequent business process 0802.

The first row at the top of FIG. 8 is the caption. The second row of FIG. 8 shows that all business processes for transactions handled in the transfer business 0400 in FIG. 3 begin with the content confirmation 0401. The third row of FIG. 8 shows that of transactions executed in the contents confirmation 0401 in FIG. 3, transactions of account transfer which charges a fee (with a fee) is 80 [%], transactions of transfer from cash which does not charge a fee (without fee) is 5 [%], transactions of transfer from account which does not charge a fee is 15 [%], and transactions of transfer from account which has a defect (rejected) is 5 [%]. The fourth row of FIG. 8 shows that of transactions executed in the fee calculation 0402 in FIG. 4, transactions of transfer from cash (receipt of money) is 20 [%], and transactions of transfer from account (transfer action) is 80 [%]. The fifth row of FIG. 8 shows that all transactions executed in the receipt of money 0403 in FIG. 4 proceed to the transfer action 0404. The sixth row of FIG. 8 shows that all of the business processes for the transactions executed in the transfer action 0404 in FIG. 4 end there.

As will be understood from FIGS. 7 and 8, for transactions handled in business processes and business which constitute “the business 0200 supported by the method for calculating a loss in business 0100” in the embodiment shown in FIG. 2, the business-specific process transition probability 0112 denotes the probability that a transaction executed in a preceding business process will be executed in a subsequent business process. Here, the business-specific process transition probability 0112 corresponds to “process transition probability in business” in the claims. In addition, the second row of the business-specific process transition probability 0112 corresponds to “starting process” in the claims, and the sixth row (last row) corresponds to “ending process” in the claims.

Further, although a description will be omitted, a similar business-specific process transition probability 0112 is also prepared for the exchange business, etc. in FIG. 5.

[Business-Specific Error Occurrence Rate Targeted for Loan Business]

An example of the business-specific error occurrence rate 0113 in FIGS. 1 and 6, which is targeted for the loan business 0300 shown in FIG. 3, will be described with reference to FIG. 9. FIG. 9 is a diagram illustrating business-specific error occurrence rate targeted for loan business, which is used for the method for calculating a loss in business in FIG. 1.

As shown in FIG. 9, the business-specific error occurrence rate 0113 consists of a process name 0901 of a business process, and an error occurrence rate 0902 in each business process.

The first row at the top of FIG. 9 is the caption. The second row of FIG. 9 shows that an error occurrence rate in the credit investigation 0301 of the loan business 0300 in FIG. 3 is 3.00 [%]. Likewise, the third row of FIG. 9 shows that an error occurrence rate in the collateral evaluation 0302 of the loan business 0300 in FIG. 3 is 4.12 [%]. The fourth row of FIG. 9 shows that an error occurrence rate in the condition settlement 0303 of the loan business 0300 in FIG. 3 is 0.89 [%]. The fifth row of FIG. 9 shows that an error occurrence rate in the loan action 0304 of the loan business 0300 in FIG. 3 is 0.01 [%] Here, an error occurrence rate e [%] means that if the number of transactions handled in the business 0200 is N, an expectation of transactions in which an error occurs is eN/100.

[Business-Specific Error Occurrence Rate Targeted for Transfer Business]

An example of the business-specific error occurrence rate 0113 in FIGS. 1 and 6, which is targeted for the transfer business 0400 shown in FIG. 4, will be described with reference to FIG. 10. FIG. 10 is a diagram illustrating business-specific error occurrence rate targeted for the transfer business, which is used for the method for calculating a loss in business in FIG. 1.

As shown in FIG. 10, as is the case with FIG. 9, the business-specific error occurrence rate 0113 consists of a process name 1001 of a business process, and an error occurrence rate 1002 in each business process.

The first row at the top of FIG. 10 is the caption. The second row of FIG. 10 shows that an error occurrence rate in the content confirmation 0401 of the transfer business 0400 in FIG. 4 is 1.01 [%]. The third row of FIG. 10 shows that an error occurrence rate in the fee calculation 0402 of the transfer business 0400 in FIG. 4 is 0.22 [%]. The fourth row of FIG. 10 shows that an error occurrence rate in the receipt of money 0403 of the transfer business 0400 in FIG. 4 is 0.32 [%]. The fifth row of FIG. 10 shows that an error occurrence rate in the transfer action 0404 of the transfer business 0400 in FIG. 4 is 0.03 [%]. Here, the meaning of the error occurrence rate is the same as that described above.

As will be understood from FIGS. 9 and 10, the business-specific error occurrence rate 0113 denotes the probability that an error will occur in each business process constituting “the business 0200 supported by the method for calculating a loss in business 0100” in the embodiment shown in FIG. 2. Here, it is to be noted that this business-specific error occurrence rate 0113 corresponds to “an process-specific error occurrence rate in business” in the claims.

[Business-Specific Loss Probability Distribution Targeted for Loan Business]

An example of the business-specific loss probability distribution 0114 in FIGS. 1 and 6, which is targeted for the loan business 0300 shown in FIG. 3, will be described with reference to FIG. 11. FIG. 11 is a diagram illustrating business-specific loss probability distribution targeted for the loan business, which is used for the method for calculating a loss in business in FIG. 1.

As shown in FIG. 11, the business-specific loss probability distribution 0114 consists of a process name 1101 of a business process, an expectation 1102 of a loss produced when an error occurs in each business process, and a standard deviation 1103 of the loss.

The first row at the top of FIG. 11 is the caption. The second row of FIG. 11 shows that a loss produced when an error occurs in the credit investigation 0301 of the loan business 0300 in FIG. 3 forms the normal distribution based on expectation 2,000 [yen] and standard deviation 200 [yen]. This means that the probability F(x) that a loss produced when an error occurs in the credit investigation 0301 will be x [yen] or less is given by the following equation (equation 1) using expectation μ, and standard deviation σ, of the loss. Here, μ is an integrand variable.

$$F ( x ) = {\int }_{- ∞}^{x} \frac{1}{\sqrt{2 π} σ} {u}^{- \frac{{( u - μ )}^{2}}{2 {σ}^{2}}} ⅆ u \qquad Equation 1$$

Likewise, the third row of FIG. 11 shows that a loss produced when an error occurs in the collateral evaluation 0302 of the loan business 0300 in FIG. 3 forms the normal distribution based on expectation 4,000 [yen] and standard deviation 100 [yen]. The fourth row of FIG. 11 shows that a loss produced when an error occurs in the condition settlement 0303 of the loan business 0300 in FIG. 3 forms the normal distribution based on expectation 1,000 [yen] and standard deviation 300 [yen]. The fifth row of FIG. 11 shows that a loss produced when an error occurs in the loan action 0304 of the loan business 0300 in FIG. 3 forms the normal distribution based on expectation 3,000 [yen] and standard deviation 500 [yen].

[Business-Specific Loss Probability Distribution Targeted for Transfer Business]

An example of the business-specific loss probability distribution 0114 in FIGS. 1 and 6, which is targeted for the transfer business 0400 shown in FIG. 4, will be described with reference to FIG. 12. FIG. 12 is a diagram illustrating business-specific loss probability distribution targeted for the transfer business, which is used for the method for calculating a loss in business in FIG. 1.

As shown in FIG. 12, as is the case with the example in FIG. 11, the business-specific loss probability distribution 0114 consists of a process name 1201 of a business process, an expectation 1202 of a loss produced when an error occurs in each business process, and a standard deviation 1203 of the loss.

The first row at the top of FIG. 12 is the caption. The second row of FIG. 12 shows that a loss produced when an error occurs in the content confirmation 0401 of the transfer business 0400 in FIG. 4 forms the normal distribution based on expectation 400 [yen] and standard deviation 40 [yen]. The third row of FIG. 12 shows that a loss produced when an error occurs in the fee calculation 0402 of the transfer business 0400 in FIG. 4 forms the normal distribution based on expectation 100 [yen] and standard deviation 5 [yen]. The fourth row of FIG. 12 shows that a loss produced when an error occurs in the receipt of money 0403 of the transfer business 0400 in FIG. 4 forms the normal distribution based on expectation 800 [yen] and standard deviation 100 [yen]. The fifth row of FIG. 12 shows that a loss produced when an error occurs in the transfer action 0404 of the transfer business 0400 in FIG. 4 forms the normal distribution based on expectation 200 [yen] and standard deviation 50 [yen].

As will be understood from FIGS. 11 and 12, the business-specific loss probability distribution 0114 denotes the probability distribution that is formed by a loss produced when an error occurs in each business process constituting “the business 0200 supported by the method for calculating a loss in business 0100” in the embodiment shown in FIG. 2. This business-specific loss probability distribution 0114 is equivalent to “process-specific loss probability distribution in business” in the claims.

It is to be noted that as a matter of course, a loss produced when an error occurs may form probability-distribution other than the normal distribution; for example, the loss may form uniform distribution, constant distribution, Weibull distribution or the like. At this time, parameters relating to the probability distribution, which are included in the business-specific loss probability distribution 0114, are not limited to the expectation and standard deviation of the probability distribution.

[Transaction-Specific Loss Calculating Step]

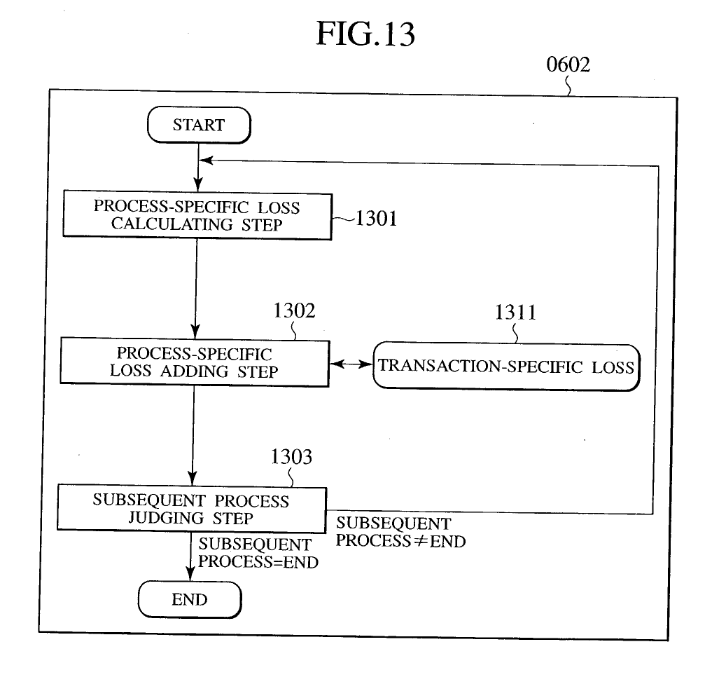

An example of the transaction-specific loss calculating step 0602 in FIG. 6 will be described with reference to FIG. 13. FIG. 13 is a flowchart detailing the transaction-specific loss calculating step in FIG. 6.

As shown in FIG. 13, the transaction-specific loss calculating step 0602 in FIG. 6 includes a process-specific loss calculating step 1301, a process-specific loss adding step 1302, and a subsequent process judging step 1303. It is to be noted that a transaction-specific loss 1311 is data.

In the process-specific loss calculating step 1301, a loss which occurs when a transaction is executed in each business process is calculated using the business-specific error occurrence rate 0113 and the business-specific loss probability distribution 0114 which have been obtained in the business-specific information obtaining step 0601 in FIG. 6. In the case of the loan business 0300 shown in FIG. 3, since a transaction is first executed in the credit investigation 0301, a loss which occurs in the credit investigation 301 is first calculated. Likewise, in the case of the transfer business 0400 shown in FIG. 4, since a transaction is first executed in the content confirmation 0401, a loss which occurs in the content confirmation 0401 is first calculated. A method for calculating a loss in each business process will be described later.

In the process-specific loss adding step 1302, a loss in each business process, which has been calculated in the preceding process-specific loss calculating step 1301, is added to the transaction-specific loss 1311.

In the subsequent process judging step 1303, a subsequent process for a transaction is judged using the business-specific process transition probability 0112 obtained in the business information obtaining step 0601 in FIG. 6. How to judge the subsequent process will be described later.

If it is judged in the subsequent process judging step 1303 that the subsequent process is not END (END in FIGS. 3 and 4), after returning to the process-specific loss calculating step 1301, a loss produced in the subsequent process (in the case of FIG. 4, the subsequent process after the fee calculation 0402 is either the receipt of money 0403 or the transfer action 0404) is calculated. On the other hand, if the subsequent process is judged to be END in the subsequent process judging step 1303, the processing ends. In this connection, in FIG. 3, if the credit investigation 0301 results in rejection, the subsequent process is judged to be END in the subsequent process judging step 1303 in FIG. 13, and consequently the processing for the transaction ends.

Going through the processing from the process-specific loss calculating step 1301 to the subsequent process judging step 1303, the sum of losses calculated for each business process that executes a transaction (in the case of FIG. 3, for each of the credit investigation 0301, the collateral evaluation 0302, etc.) is stored in a storage device as the transaction-specific loss 1311. The transaction-specific loss 1311 is the result of the transaction-specific loss calculating step 0602. In the transaction-specific loss adding step 0603 in FIG. 6, the transaction-specific loss 1311 is added to the business-specific loss 0115.

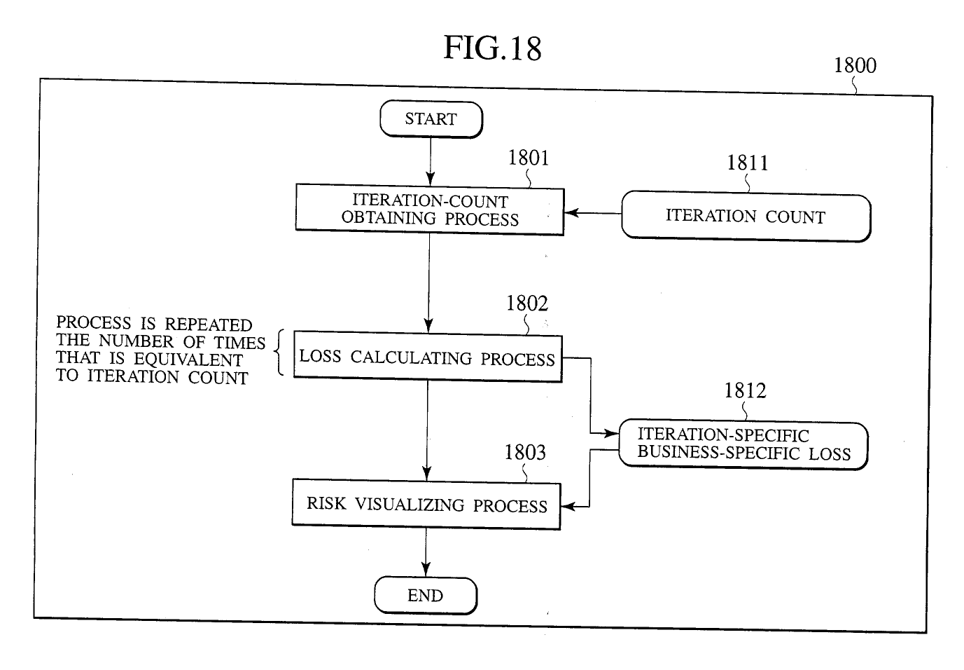

In this connection, this transaction-specific loss adding step 0602 (from START 1300 to END 1304) is executed the number of times according to the business information shown in FIG. 5. For example, if the business name 0501 in FIG. 5 is loan business, the number of transactions 0502 is 36,483 times. Accordingly, the transaction-specific loss adding step 0602 is executed 36,483 times. As a matter of course, individual steps 1301, 1302, 1303 are executed more often than 36,483 times (the number of times depends on the business transition probability 0112). Moreover, if 36,483 times, which is the number of times the transaction-specific loss adding step 0602 from START 1300 to END 1304 is executed, is treated as a series, this series of the execution is repeated the number of times that is equivalent to the number of iteration 1811 in FIG. 18 (the series constituted of 36,483 times is repeated tens of thousands times or millions times).

[Process-Specific Loss Calculating Step]

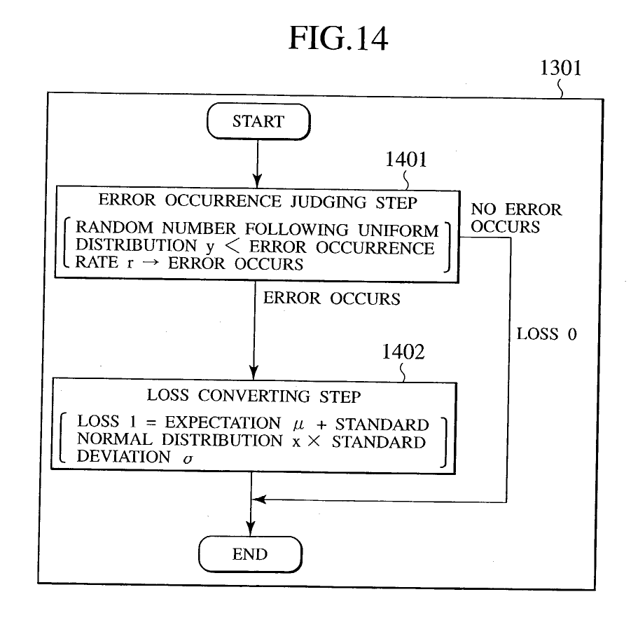

An example of the process-specific loss calculating step 1301 in FIG. 13 will be described with reference to FIG. 14. FIG. 14 is a flowchart detailing the process-specific loss calculating step in FIG. 13.

As shown in FIG. 14, the process-specific loss calculating step 1301 includes an error occurrence judging step 1401 and a loss converting step 1402.

In the error occurrence judging step 1401, a judgment is made as to whether or not an error occurs in business processes in which a transaction is executed (in FIG. 3, the business processes are the credit investigation 0301, the collateral evaluation 0302, etc.). The occurrence of an error is judged by comparing a random number following uniform distribution y, a range of which is [0, 1], with an error occurrence rate r of the business process in the business-specific error occurrence rate 0113 (refer to FIGS. 9 and 10) obtained in the business information obtaining step 0601 (refer to FIG. 6). In this case, if the following equation 2 holds, it is judged that an error will occur in the business process.

y<r Equation 2

Here, a probability that the equation 2 will hold is r. Accordingly, by this judging method, a probability that an error will occur in the business process is equivalent to the error occurrence rate r of the business process. The range [0, 1] means a range from 0 to 0.999 . . . (more than 0 and less than 1). The random number following uniform distribution means a random number, probability distribution of which is uniform; for example, it is a probability that a dice will show each number.

A supplementary explanation will be made of the error occurrence judging step 1401. As shown in FIG. 9, a business-specific error occurrence rate targeted for the loan business 0300 in FIG. 3 is 3.00 [%] for the credit investigation 0301. In other words, it is r=0.03. For this reason, in the error occurrence judging step 1401, the random number following uniform distribution y is generated to compare y with the error occurrence rate r=0.03. Then, if the random number following uniform distribution y is less than 0.03, it is judged that “an error occurs” (if the random number following uniform distribution y<the error occurrence rate r, it is judged that “an error occurs”). On the other hand, if the random number following uniform distribution y is greater than or equal to the error occurrence rate r=0.03, it is judged that “an error does not occur”.

On this point, the processing is the same as that of the collateral evaluation 0302. In addition, since a business-specific error occurrence rate of the contents confirmation 0401 targeted for the transfer business 0400 in FIG. 4 is also handled in the same manner, the description thereof will not be repeated here.

If it is judged in the error occurrence judging step 1401 that an error occurs, after proceeding to the loss converting step 1402, a loss 1 produced when the error occurs is calculated. On the other hand, if it is judged in the error occurrence judging step 1401 that an error does not occur, a loss is set to 0 before the process-specific loss calculating step 1301 ends.

In the loss converting step 1402, a random number following uniform distribution y, a range of which is [0, 1], is first generated, and then y is converted into a random number following standard normal distribution x by use of an inverse transform method, etc. The inverse transform method is a method for converting the random number following uniform distribution y into the random number following standard normal distribution x by the following equation 3 using an inverse function Φ⁻¹ of a distribution function Φ of the standard normal distribution.

x=Φ⁻¹(y) Equation 3

Because it is actually difficult to calculate Equation 3 analytically, the algorithm of Moro is applied on the assumption that μ=y−0.5. The algorithm of Moro is detailed in “Guide to Finance Engineering” by Masaaki Kijima, Izumi Nagayama, Yoshiyuki Oomi, Union of Japanese Scientists and Engineers, part III, pp. 133-135, 1996, which is a publicly known example. The details will be shown as follows.

(a) |u|≦0.42

$$x = {Φ}^{- 1} ( y ) = u \frac{{a}_{0} + {a}_{1} {u}^{2} + {a}_{2} {u}^{4} + {a}_{3} {u}^{6}}{1 + {b}_{1} {u}^{2} + {b}_{2} {u}^{4} + {b}_{3} {u}^{6} + {b}_{4} {u}^{8}} \qquad Equation 4$$

a₀=2.50662823884 Equation 5

a₁=−18.61500062529 Equation 6

a₂=41.39119773534 Equation 7

a₃=−25.44106049637 Equation 8

b₁=−8.47351093090 Equation 9

b₂=23.08336743743 Equation 10

b₃=−21.06224101826 Equation 11

b₄=3.13082909833 Equation 12

(b) |u|>0.42

$$\begin{matrix}x = {Φ}^{- 1} ( y ) = \frac{{c}_{0}}{2} + {\sum }_{n = 1}^{8} {c}_{n} {T}_{n} ( z ) ( u > 0 ) & Equation 13 \\ x = {Φ}^{- 1} ( y ) = - \frac{{c}_{0}}{2} - {\sum }_{n = 1}^{8} {c}_{n} {T}_{n} ( z ) ( u < 0 ) & Equation 14\end{matrix}$$

z=k₁[2ln{−ln(0.5−|u|)}−k₂ Equation 15

T₀(z)=1, T₁(z)=z, Tₙ(z)=2zTₙ₋₁(z)−Tₙ₋₂(z)(n≧2) Equation 16

c₀=7.7108870705487895 Equation 17

c₁=2.7772013533685169 Equation 18

c₂=0.3614964129261002 Equation 19

c₃=0.0373418233434554 Equation 20

c₄=0.0028297143036967 Equation 21

c₅=0.0001625716917922 Equation 22

c₆=0.0000080173304740 Equation 23

c₇=0.0000003840919865 Equation 24

c₈=0.0000000129707170 Equation 25

k₁=0.4179886424926431 Equation 26

k₂=4.2454686881376569 Equation 27

When converting the random number following uniform distribution y into the random number following standard normal distribution x, as a matter of course, the Box-Muller method, or the modified Box-Muller method, other than the inverse transform method may also be used. The loss 1 produced when an error occurs in a business process is calculated by the following equation using expectation μ, standard deviation σ, and random number following standard normal distribution x, of a loss of the business process in the business-specific loss probability distribution 0114 which have been obtained in the business information obtaining step 0601.

1=μ+σx Equation 28

The loss 1 produced when an error occurs in the business process, which is calculated by Equation 28, forms normal distribution N(μ, σ) based on expectation μ and standard deviation σ. It is to be noted that the random number following standard normal distribution x shown here is a random number, a mean value of which is 0, and a standard deviation σ of which is 1.

[Subsequent Process Judging Step]

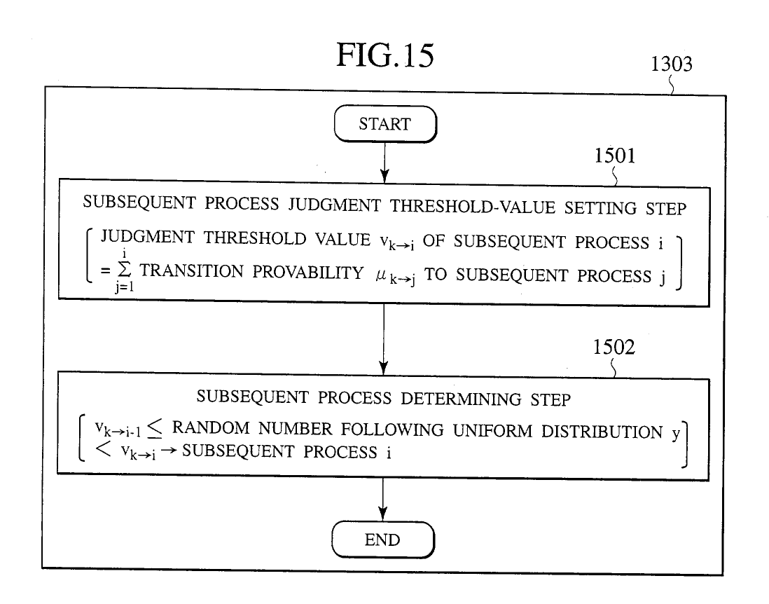

An example of the subsequent process judging step 1303 in FIG. 13 will be described with reference to FIG. 15. FIG. 15 is a flowchart detailing the subsequent process judging step in FIG. 13. As shown in FIG. 15, the subsequent process judging step 1303 in FIG. 13 includes a subsequent process judgment threshold-value setting step 1501 and a subsequent process determining step 1502.

In the subsequent process judgment threshold-value setting step 1501, a threshold value v_{k→j} is calculated by the following equation (Equation 29). The threshold value is used to judge that a subsequent process of the business process k is the business process j. The judgment is made based on transition probability μ_{k→j} (from a business process k to a business process j) included in the business-specific process transition probability 0112 (refer to FIG. 11) which has been obtained in the business-specific information obtaining step 0601.

$${v}_{k \to i} = {\sum }_{j = 1}^{i} {u}_{k \to j} \qquad Equation 29$$

Next, in the subsequent process determining step 1502, a random number following uniform distribution y is generated. If the generated random number following uniform distribution y satisfies the following equation (Equation 30), it is determined that a subsequent process is the business process j.

V_{k→j-1}≦y<V_{k→j} Equation 30

In this case, if V_{k→j}=0 in Equation 30, a probability that the equation 30 will hold is μ_{k→j}. Accordingly, this judging method can realize transition of a business process according to the business-specific process transition probability 0112.

[Example in which the Subsequent Process Judging Step is Applied to the Credit Investigation]

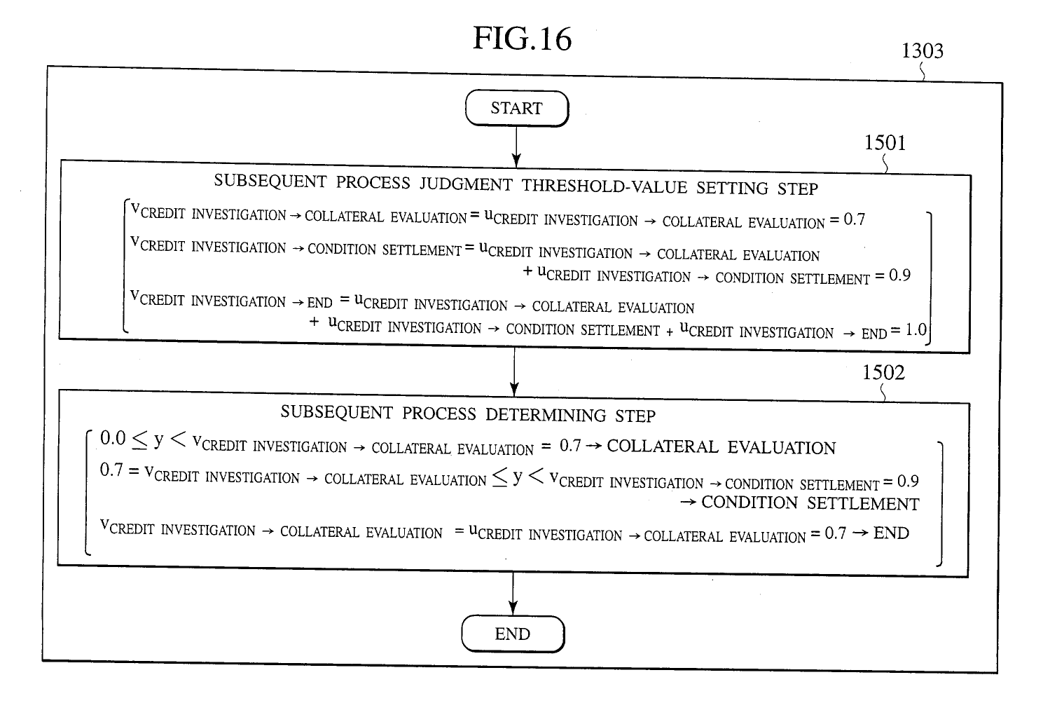

An example in which the subsequent process judging step 1303 shown in FIG. 15 is applied to the credit investigation 0301 of the loan business 0300 in FIG. 3 will be described with reference to FIG. 16. It is to be noted that for convenience of explanation, the numbers of steps in FIG. 15 are the same as those in FIG. 16.

In the subsequent process judgment threshold-value setting step 1501 in FIG. 16, by use of a probability of transition from the credit investigation 0301 to the collateral evaluation 0302 (μ credit investigation→collateral evaluation=0.7), a probability of transition from the credit investigation 0301 to the condition settlement 0303 (μ credit investigation→condition settlement=0.2), and a probability of transition from credit investigation 0301 to end (μ credit investigation→end=0.1), which are stored in the business-specific process transition probability 0112 of the loan business 0300 shown in FIG. 7, threshold values (v credit investigation→collateral evaluation, v credit investigation→condition settlement, and v credit investigation→end) used to judge that a subsequent process of the credit investigation 0301 is the collateral evaluation 0302, the condition settlement 0303, or the end are calculated in the following manner. It is to be noted that as shown in the equation 31, characters including→which follow μ or v are subscripts.

v_{credit investigation→collateral evaluation}=u_{credit investigation→collateral evaluation}=0.7 Equation 31

V_{credit investigation→condition settlement}=u_{credit investigation→collateral evaluation}+u_{credit investigation→condition settlement}=0.9 Equation 32

V_{credit investigation→end}=u_{credit investigation→collateral evaluation}+u_{credit investigation→condition settlement}+u_{credit investigation→end}=1.0 Equation 33

In the subsequent process determining step 1502, if the generated random number following uniform distribution y is 0 or more and is smaller than v credit investigation→collateral evaluation=0.7, it is judged that the subsequent process is the collateral evaluation 0302. In addition, if the generated random number following uniform distribution y is greater than or equal to v credit investigation→collateral evaluation=0.7 and is smaller than v credit investigation→condition settlement=0.9, it is judged that the subsequent process is the condition settlement 0303. Moreover, if the generated random number following uniform distribution y is greater than or equal to v credit investigation→condition settlement=0.9 and is smaller than v credit investigation→end=1.0, it is judged that the subsequent business process is end. At this time, a probability of becoming 0≦y<0.7 is u credit investigation→collateral evaluation=0.7. In addition, a probability of becoming 0.7≦y<0.9 is u credit investigation→condition settlement=0.2. Further, a probability of becoming 0.9≦y<1.0 is u credit investigation→end=0.1.

Therefore, according to the business-specific process transition probability 0112 of the loan business 0300, the transition from the credit investigation 0301 to the collateral evaluation 0302, the condition settlement 0303, and end is made.

[Business-Specific Loss]

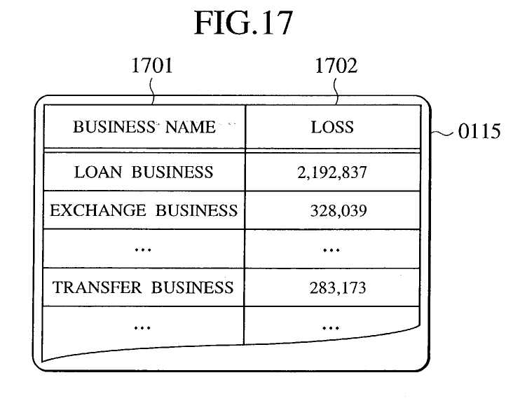

An example of the business-specific loss 0115 in FIGS. 1 and 6 will be described with reference to FIG. 17.

The business-specific loss 0115 shown in FIG. 17 consists of the business name 1701 and the loss 1702. The business name 1701 includes loaned money (loan business), exchange (exchange business), and account transfer (transfer business).

The example in FIG. 17 shows that losses which will occur in the future from the loan business, the exchange business, and the account transfer business are 2,192,837 [yen], 328,039 [yen], and 283,173 [yen], respectively.

[Risk Visualizing Method]

An example of a risk visualizing method using the method for calculating a loss in business 0100 (refer to FIG. 1) in the embodiment will be described with reference to FIG. 18.

The risk visualizing method 1800 shown in FIG. 18 includes an iteration-count obtaining process 1801, a loss calculating process 1802, and a risk visualizing process 1803.

In the iteration-count obtaining process 1801, an iteration count 1811 which is the number of times the loss calculating process 1802 is repeated is obtained. An iteration count which is a convenient count to fix and is also sufficient for the quantity of statistical data handled when a risk is visualized is predetermined.

In the loss calculating process 1802, a loss in business is calculated according to the method for calculating a loss in business 0100 (refer to FIG. 1). The loss calculating process 1802 is repeatedly executed the number of times that is equivalent to the iteration count 1811. For example, if the iteration count 1811 is one million times, the loss calculating process 1802 is repeated one million times. In this connection, repeating the loss calculating process 1802 one million times means that the method for calculating a loss 0100 (refer to FIG. 1) is repeated one million times.

The loss calculated in the loss calculating process 1802 is output as an iteration-specific business-specific loss 1812. Accordingly, if the iteration count 1811 is one million times, the iteration-specific business-specific loss 1812 is calculated the number of time that is equivalent to one million times×the number of business stored in the business information 0111 (refer to FIG. 5). This permits variance of losses to be exactly calculated.

In the risk visualizing process 1803, the iteration-specific business-specific loss 1812 is read to display a graph of losses in business, and statistic (expectation, standard deviation, etc.).

[Iteration-Specific Business-Specific Loss]

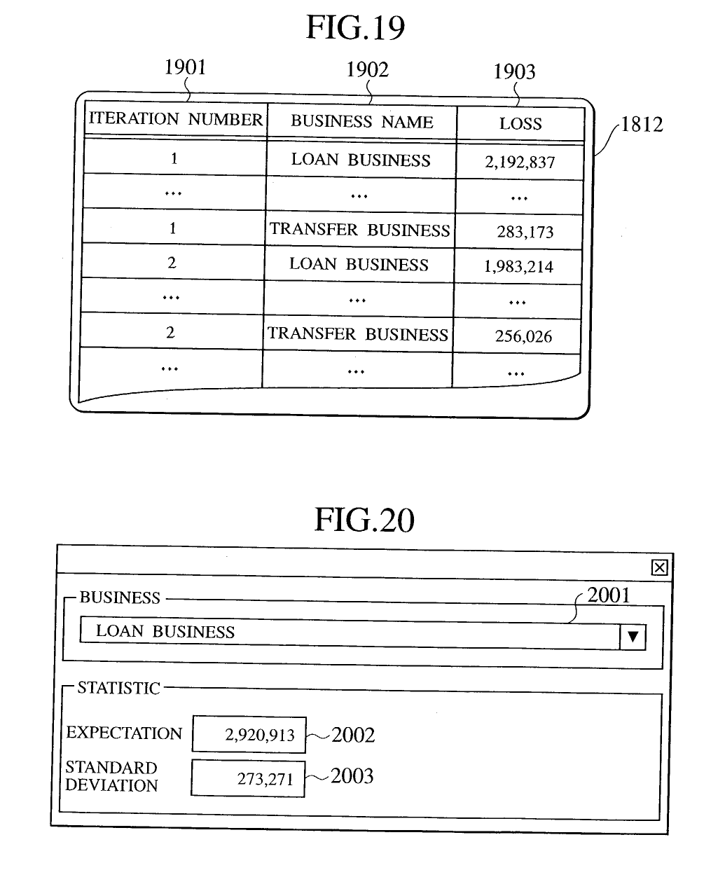

An example of the iteration-specific business-specific loss 1812 in FIG. 18 will be described with reference to FIG. 19.

As shown in FIG. 19, the iteration-specific business-specific loss-1812 consists of an iteration number 1901, a business name 1902, and a loss 1903.

The iteration-specific business-specific loss 1812 is equivalent to a loss to which the business-specific loss 0115 shown in FIG. 17 is added the number of times, that is to say, an iteration count. An example in FIG. 19 shows that losses which will occur in the future from the loan business and the account transfer business for iteration number 1 are 2,192,837 [yen] and 283,173 [yen], respectively, and that losses which will occur in the future from the loan business and the account transfer business for iteration number 2 are 1,983,214 [yen] and 256,026 [yen], respectively.

[Risk Visualizing Process in Risk Visualizing Method]

An example of the risk visualizing process 1803 in the risk visualizing method 1800 shown in FIG. 18 will be described with reference to FIG. 20.

As shown in FIG. 20, in the risk visualizing process 1803, the iteration-specific business-specific loss 1812 is inputted to display an expectation 2002 and a standard deviation 2003 as statistic of a loss in specified business 2001. Here, expectation li, and standard deviation σi, of a loss in business i are calculated by the following equations (Equations 34 and 35).

$${\overline{l}}_{i} = \frac{1}{N} {\sum }_{n = 1}^{N} {l}_{i , n} \qquad Equation 34$$

$${σ}_{i} = \frac{1}{N - 1} {\sum }_{n = 1}^{N} {( {l}_{i , n} - {\overline{l}}_{i} )}^{2} \qquad Equation 35$$

N: Iteration count

l_{i,n}: Loss in business i for iteration number n

In the risk visualizing process 1803, besides the statistic of the business-specific loss, statistic for the total loss to which losses in a plurality of business, or in all business, are added may also be calculated to display the statistic. For example, an expectation, and a standard deviation, of the total loss to which losses of all business are added are calculated by the following equations (Equations 36 and 37).

$$\begin{matrix}{\overline{l}}_{i} = \frac{1}{N} {\sum }_{n = 1}^{N} {\sum }_{i = 1}^{m} {l}_{i , n} & Equation 36 \\ σ = \frac{1}{N - 1} {\sum }_{n = 1}^{N} {( {\sum }_{i = 1}^{m} {l}_{i , n} - \overline{l} )}^{2} & Equation 37\end{matrix}$$

m: Number of business

Moreover, information displayed in the risk visualizing process 1803 is not limited to the statistic of the loss. As a matter of course, the displayed information may also be a graph of losses by iteration number, etc.

According to the method for calculating a loss of this embodiment, losses which will occur in the future in business constituted of a plurality of business processes, and variance (distribution) of the losses in particular, can be exactly calculated. In particular, losses which will occur in the future in the bank's business such as loan business or account transfer business, and their variance (distribution) in particular, can be exactly calculated. In this connection, in the field of banking risk management, calculation of losses occurring in business of a banking institution, and exact calculation of their variance in particular, are becoming important. According to the calculating method of this embodiment, the result of calculation fully satisfying the needs can be obtained.

[Loss Calculating Device]

Lastly, a loss calculating device 1, which executes the method for calculating a loss 0100 and a calculation program, will be described.

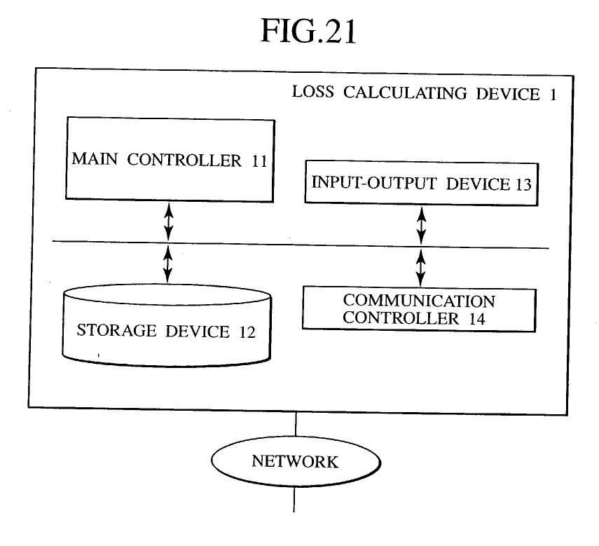

As shown in FIG. 21, the loss calculating device 1 has a configuration in which a main controller 11, a storage device 12, an input-output device 13, and a communication controller 14 are connected to a bus. The main controller 11 comprises a CPU (Central Processing Unit), and a RAM (Random Access Memory). The loss calculating device 1 is subject to centralized control by the main controller 11. The main controller 11 comprises, as a software configuration (refer to FIG. 1), a function of executing the business information obtaining step 0101, a function of executing the subsequent process judging step 1303 (refer to FIG. 15), and a function of executing the business loss calculating step 0102. In addition, the main controller 1 comprises, as a software configuration (refer to FIG. 18), a function of executing the iteration-count obtaining process 1801, a function of executing the loss calculating process 1802, and a function of executing the risk visualizing process 1803. It is to be noted that the function of executing the loss calculating process 1802 includes the function of executing the business information obtaining step 0101 described above, and the business loss calculating step 0102.

The storage device 12 comprises a hard disk. After the business 0200 (refer to FIG. 2 [FIGS. 3, 4, . . . ]) supported by the method for calculating a loss in business, the business information 0111 (refer to FIG. 5), the business-specific process transition probability 0112 (refer to FIG. 1 [FIGS. 7, 8, . . . ], the business-specific error occurrence rate (refer to FIG. 1 [FIGS. 9, 10, . . . ]), the business-specific loss probability distribution 0114 (FIG. 1 [FIGS. 11, 12, . . . ]), the iteration count 1811 (refer to FIG. 18), the business-specific loss 0115 (refer to FIGS. 1 and 6), and the iteration-specific business-specific loss 1812 (refer to FIG. 18) are obtained, the storage device 12 stores the obtained information. Modes of obtaining the information include keyboard input, and obtaining through a network. In addition, the storage device stores a program that provides each function of the main controller 11. This program is loaded into the RAM and is then executed in the CPU before the program provides each of the above-mentioned functions.

Additionally, a keyboard, a CD-ROM drive, a mouse, a monitor and the like are connected to the input-output device 13 through an I/O device. The communication controller 14 comprises NIC, and has a function of communicating by TCP/IP, etc.

It is to be noted that the business information 0111, the business-specific process transition probability 0112, the business-specific error occurrence rate 0113, the business-specific loss probability distribution 0114, etc., which are stored in the storage device 12, are inputted from the keyboard or the CD-ROM drive, which is connected to the input-output device 13, or the communication controller 14. In addition, the business-specific loss 0115, the iteration-specific business loss 1,812, etc. are output through a monitor connected to the input-output device 13 or the communication controller 14.

The present invention described above can be broadly modified and embodied without being limited to the above-mentioned embodiments.

For example, although the bank's business has been described, the present invention is not limited to the bank's business. The present invention can also be applied to other kinds of business. In addition, the above-mentioned flowcharts are to be grasped as programs for executing the loss calculating method. Moreover, the programs are transmitted via a network, or are stored in a storage medium such as CD-R to put them into circulation. Additionally, the loss calculating device can also be configured to be connected to a network such as a LAN, a WAN, and an intranet so that a loss, etc. are calculated according to a request from an outside requester and then the calculations are output to the requester.

According to the present invention, for business constituted of a plurality of business processes, using transition probabilities of the business processes permits losses which will occur in the future in the business to be calculated more properly.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A method for calculating a loss in business, said method inputting an error occurrence rate in business constituted of a plurality of business processes, and probability distribution of losses produced when an error occurs in the business, to calculate a loss which will occur in the future in the business,
wherein a business process transition probability, which denotes a probability that a transaction executed in a preceding business process will be executed in a subsequent business process, is used for a transaction handled in the business to calculate a loss which will occur in the future in the business.

2. A method for calculating a loss in business according to claim 1, wherein statistic of a loss which will occur in the future in the business is calculated by applying the method for calculating a loss in business multiple times.

3. A method for calculating a loss in business as in claim 1 or 2, wherein a loss which will occur in the future in bank's business is calculated by the method for calculating a loss in business.

4. A method for calculating a loss in business according to claim 3, wherein statistic of a loss which will occur in the future in the bank's business is calculated by the method for calculating a loss in business.

5. A loss calculating program for calculating a loss in business, in order to calculate a loss in business including a series of processes from a starting process to an ending process, said loss calculating program instructing a computer to execute the steps of:
if there are a plurality of subsequent processes for a preceding process in the business, obtaining process transition probabilities in the business, said process transition probabilities showing probabilities that transition from the preceding process to each of the subsequent processes will be made;
obtaining process-specific error occurrence rates in the business, which show error occurrence rates by process in the business;
obtaining process-specific loss probability distribution in the business, which shows probability distribution of losses produced when an error occurs in each process of the business;
determining a process subsequent to a certain process by use of the process transition probabilities in the business;
calculating a loss produced in the determined process by use of the process-specific error occurrence rates in the business and the process-specific loss probability distribution in the business; and
adding the loss obtained for each of the processes.

6. A loss calculating program for calculating a loss in business according to claim 5, said loss calculating program further instructing the computer to execute the steps of:
obtaining business information that shows the number of transactions in the business; and
calculating a loss in the business the number of times that is equivalent to the number of transactions, a series of processes from the starting process to the ending process being handled as one transaction of the business.

7. A loss calculating program for calculating a loss in business according to claim 5, wherein said step for determining a process subsequent to said certain process is a step for determining a subsequent process according to a threshold value used for judging the subsequent process.

8. A loss calculating program for calculating a loss in business according to claim 6, wherein said step for determining a process subsequent to said certain process is a step for determining a subsequent process according to a threshold value used for judging the subsequent process.

9. A loss calculating program for calculating a loss in business according to claim 6, said loss calculating program further instructing the computer to execute the steps of:
inputting an iteration count showing the number of times calculation is repeated;
repeatedly executing, the number of times that is equivalent to the iteration count, said step for calculating a loss in the business the number of times that is equivalent to the number of transactions; and
calculating statistic according to a loss calculated at each number of the iteration count.

10. A loss calculating program for calculating a loss in business according to claim 7, said loss calculating program further instructing the computer to execute the steps of:
inputting an iteration count showing the number of times calculation is repeated;
repeatedly executing, the number of times that is equivalent to the iteration count, said step for calculating a loss in the business the number of times that is equivalent to the number of transactions; and
calculating statistic according to a loss calculated at each number of the iteration count.

11. A loss calculating program for calculating a loss in business according to claim 8, said loss calculating program further instructing the computer to execute the steps of:
inputting an iteration count showing the number of times calculation is repeated;
repeatedly executing, the number of times that is equivalent to the iteration count, said step for calculating a loss in the business the number of times that is equivalent to the number of transactions; and
calculating statistic according to a loss calculated at each number of the iteration count.

12. A loss calculating device for calculating a loss in business, comprising: a main controller; a storage device; an input-output device; and a communication controller;
wherein said main controller executes the loss calculating program for calculating a loss in business according to claim 5.

13. A loss calculating device for calculating a loss in business, comprising: a main controller; a storage device; an input-output device; and a communication controller;
wherein said main controller executes the loss calculating program for calculating a loss in business according to claim 6.

14. A loss calculating device for calculating a loss in business, comprising: a main controller; a storage device; an input-output device; and a communication controller;
wherein said main controller executes the loss calculating program for calculating a loss in business according to claim 7.

15. A loss calculating device for calculating a loss in business, comprising: a main controller; a storage device; an input-output device; and a communication controller;
wherein said main controller executes the loss calculating program for calculating a loss in business according to claim 8.

16. A loss calculating device for calculating a loss in business, comprising: a main controller; a storage device; an input-output device; and a communication controller;
wherein said main controller executes the loss calculating program for calculating a loss in business according to claim 9.

17. A loss calculating device for calculating a loss in business, comprising: a main controller; a storage device; an input-output device; and a communication controller;
wherein said main controller executes the loss calculating program for calculating a loss in business according to claim 10.

18. A loss calculating device for calculating a loss in business, comprising: a main controller; a storage device; an input-output device; and a communication controller;
wherein said main controller executes the loss calculating program for calculating a loss in business according to claim 11.
